(19) United States
(12) Patent Application Publication
(10) Pub. No.: US 2003/0134585 A1
(43) Pub. Date: Jul. 17, 2003

(54) Shellfish shucking tool

(76) Inventor: Rosario M. Maloni, St. Augustine, FL (US)

Correspondence Address: Thomas C. Saitta, Rogers Towers Bailey Jones & Gay, P.A., Suite 1500, 1301 Riverplace Blvd., Jacksonville, FL, 32202, US

(21) Appl. No.: 10/342,815

(22) Filed: Jan. 14, 2003

Related U.S. Application Data
(60) Provisional application No. 60/349,277, filed on Jan. 14, 2002.

(51) Int. Cl. A22C 29/04

(52) U.S. Cl. 452/17

(57) ABSTRACT

A shucking tool having a leveraging blade extending from a handle, wherein the leveraging blade is non-planar and has an end portion angularly or curvedly joined to a base portion by a junction, such that a bivalve shellfish can be opened at the hinge with a pivoting, leveraging motion rather than by linearly jamming a flat straight blade into the hinge. Preferably, a straight blade extends from the handle opposite from the leveraging blade.

This application claims the benefit of U.S. Provisional Application Serial No. 60/349,277, filed Jan. 14, 2002.

### BACKGROUND OF THE INVENTION

This invention relates generally to the field of tools or devices used to shuck or open bivalve or hinged mollusks or shellfish, such as oysters, mussels or clams, referred to herein generally as bivalve shellfish, and more particularly relates to hand tools used for this purpose.

A bivalve shellfish has two generally cupped shells joined at the base by a hinge structure formed of muscles and tendons, whereby by the hinge structure operates to open and close the two shells. When taken from the water, the shellfish reacts and maintains its shells in a tightly sealed configuration. The construction of the shellfish and the strength of the hinge is such that the shellfish cannot be easily opened. This is especially true of oysters, which have irregularly shaped, unequal shells. Cooking or steaming the oysters will cause the shell pairs to release and open, but it is highly popular to consume oysters in a raw and uncooked state. To get to the edible meat within the shells in this condition, the shell halves must be pried open.

A known hand tool for opening oysters or other bivalve shellfish is commonly referred to as an oyster knife or oyster shucker, and typically consists of a short, relatively dull, straight, flat blade having a generally elliptical lateral cross-section and which terminates in a central tip, with the blade mounted into a handle with small shoulder flanges at the junction point between the handle and the blade to stop the forward progress of the blade when thrust into the oyster. To open an oyster, the oyster is held in one hand with the hinge of the shell facing the other hand, and the tip of the blade is inserted at a point on the hinge where an indentation can be found such that the blade is less likely to slip sideways when pressure is applied. A large amount of pressure must be exerted against the hinge to break through the natural defenses of the oyster. When done correctly, the hinge is breeched and the oyster can be opened by rotating the knife blade to pry apart the shells. Unfortunately, when done incorrectly, or when the opener is not sufficiently careful, or when a particularly difficult oyster is encountered, the knife blade may slip and stab into the user's other hand. This is such a common occurrence that sturdy gloves or chain mail-like hand coverings are often used by commercial openers to protect the non-knife hand.

It is an object of this invention to provide a handheld shellfish shucking device which is simple in both construction and operation, yet which greatly simplifies and increases the efficacy and safety of the shucking operation. It is a further object to provide such a device comprising a pair of blades mounted on opposing ends of a single handle, one such blade being bent or curved in the nature of a pry bar for easily breaching the hinge to open the bivalve shellfish and the other such blade being a straight blade for removing the meat from the shellfish.

### SUMMARY OF THE INVENTION

The invention is a handheld, bivalve shellfish, shucking tool which comprises a pair of blades extending from opposite ends of a single handle. The first blade is in most respects a standard shucking blade, comprising a short, flat blade which tapers to a central tip. This first blade is not used to initially open the shellfish but instead is used to separate the shells after the hinge has been breeched if necessary and to scrape the meat from the shell once the shellfish has been opened by the second blade. The second blade is a leveraging blade in the nature of a pry bar device. It is a much shorter blade which is curved or bent near its free end such that the end portion is disposed at an angle of between about 45 to 90 degrees from the generally planar body portion which extends from the handle. The end portion may be planar or curved, and tapers slightly laterally near the end. The second blade is provided with a generally linear forward tip or edge of shorter lateral dimension than that of the body portion. The linear tip is preferably beveled so as to be somewhat wedge-shaped and of reduced thickness along its edge.

Shucking of the shellfish is accomplished in a leveraging manner similar to the use of a pry bar or crowbar. The linear edge of the second or leveraging blade is inserted into the hinge area of the bivalve shellfish, and force is applied through movement of the handle angularly relative to the shellfish rather than linearly. The shape of the leveraging blade in conjunction with one side of the shell acting as a fulcrum allows the leveraging blade to be pivoted, with the result that greater separation force than can be accomplished by thrusting a straight blade into the hinge is easily and safely applied to the hinge area in a non-linear manner.

### BRIEF DESCRIPTION OF THE DRAWINGS

FIG. 1 is a side view of he invention.

FIG. 2 is a top view of the invention.

FIG. 3 is a partial side view of an alternative embodiment for the pry blade of the invention.

FIG. 4 is a partial side view of another alternative embodiment for the pry blade of the invention.

### DETAILED DESCRIPTION OF THE INVENTION

With reference to the drawings, the invention will now be described with regard for the best mode and the preferred embodiment.

In general, the invention is a handheld shellfish shucking tool 10 comprising a generally elongated handle member 11 capable of being held in one hand and having a first end 12 and a second end 13. The handle member 11 as shown is generally rectangular and linear in configuration, but this member may be non-rectangular in cross-section, such as elliptical or circular, and may be curved or shaped in a non-linear manner for ergonomic reasons to better conform to the user's hand or palm.

A first blade member 21 is mounted to and extends from the first end 12 of the handle 11. The first blade 21 is generally constructed in the known manner for shucking blades, and is a generally flat, metal member of sufficient thickness for strength comprising a main body portion 22 generally rectangular in lateral cross-section, and a tapered portion 23 of reduced dimension on the sides, top and bottom, such that a centralized, relatively pointed but non-sharp, tip member 24 is defined on the free end of the first blade 21.

A second blade member or leveraging blade 31 extends from the opposing, second end 13 of the handle 11. This leveraging blade 31 is much shorter than the first blade 21, is composed of metal with matching strength characteristics as the first blade 21, and comprises a generally flat or planar body portion 32 of generally rectangular lateral cross-section positioned adjacent said handle 11 and an end portion 33 joined to the body portion 32 by a junction 34, such that leveraging blade 31 is non-planar over its full length. Junction 34 may be curved or angular.

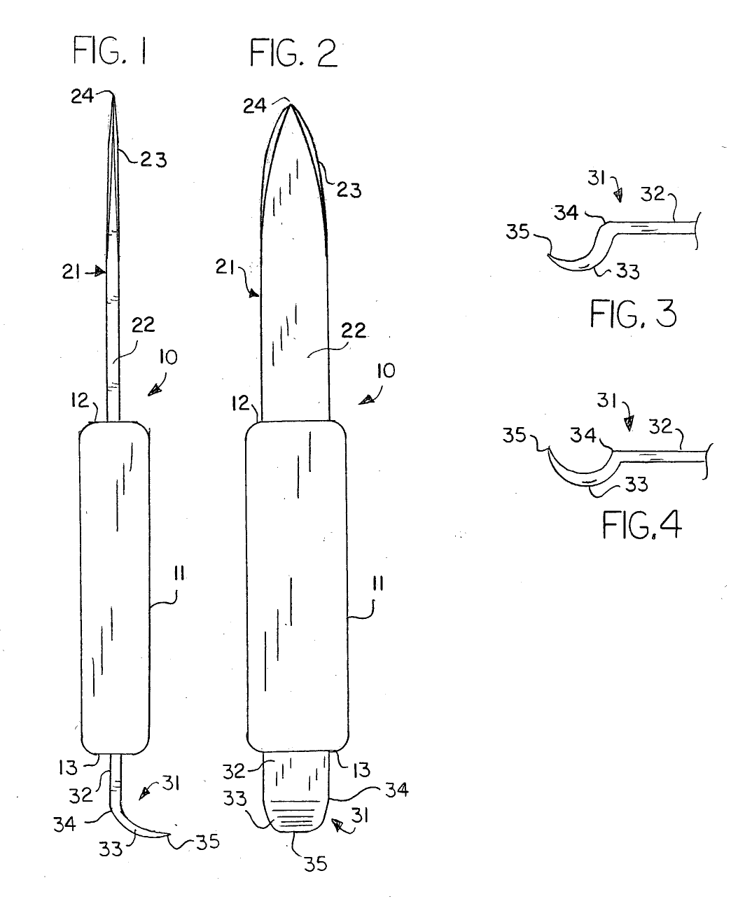

The end portion 33 is preferably generally planar or slightly curved, as seen in FIGS. 1 and 2, but may be more greatly curved as shown in FIG. 3 or FIG. 4 where the end portion 33 is curved through part or all of about 180 degrees. The end portion 33 preferably tapers slightly on the sides and is tapered or beveled on the top and bottom to define a generally linear, wedge-shaped, forward tip or edge 35, where the width of the linear edge 35 is preferably no greater than about half the width of the body portion 32. The end portion 33 is preferably joined to the body portion 32 at the junction 35 so as to be disposed at an angle between about 45 to 90 degrees from the body portion 32.

A preferred metal for the blades 21 and 31 of the tool 10 is 440C stainless steel, although other materials may be utilized. Representative preferred dimensions for the tool 10 comprise a handle 11 of about 3.5 inches in length, a width of about 1.0 inch and a thickness of about 0.625 inches, a first blade 21 of about 2.875 inches in length, a width of about 0.5 inches adjacent the first handle end 12 which reduces significantly after about 2.0 inches, and a thickness of about 0.125 inches adjacent the first handle end 12 which reduces significantly after about 1.25 inches, and a leveraging blade 31 of about 0.875 inches in length, a body portion 32 of about 0.5 inches in length, 0.675 inches in width and about 0.125 inches in thickness, and an end portion 33 of about 0.375 inches in length, a width of about 0.675 inches adjacent the junction 34 which tapers to the linear edge 35 which is about 0.250 in width, the thickness of the end portion 33 tapering significantly to the linear edge 35.

Obviously, these particular dimensions are not critical. Rather it is the overall configuration and structure of the leveraging blade 31 in combination with the handle 21 which allows the shucking tool 10 to easily and safely open the shellfish. The addition of the first blade 21 enhances the tool 10, since the configuration of this member is better for scraping the meat from the shellfish than the configuration of the leveraging blade 31.

It is understood and contemplated that equivalents and substitutions for certain elements set forth above may be obvious to those skilled in the art, and therefore the true scope and definition of the invention is to be as set forth in the following claims.

I claim:

1. A tool for opening bivalve shellfish, said tool comprising:
a handle;
a leveraging blade extending from said handle, said leveraging blade having a body portion positioned adjacent said handle and an end portion joined in a non-planar manner to said body portion, said end portion having a generally linear edge.

2. The tool of claim 1, wherein said handle comprises a first end and an opposing second end, wherein said leveraging blade extends from said second end, and further comprising a first blade extending from said first end of said handle, said first blade being generally linear and flat and having a tapered portion and a tip member.

3. The tool of claim 1, wherein said end portion of said leveraging blade is joined to said body portion by an angular junction.

4. The tool of claim 1, wherein said end portion of said leveraging blade is joined to said body portion by a curved junction.

5. The tool of claim 1, wherein said end portion is generally planar.

6. The tool of claim 1, wherein said end portion is generally curved.

7. The tool of claim 1, wherein the width of said edge of said end portion is no greater than half the width of said end portion.

8. The tool of claim 1, wherein said end portion is joined to said body portion at an angle of about 45 to 90 degrees.

9. The tool of claim 1, wherein said edge of said end portion is beveled.

10. The tool of claim 2, wherein said end portion of said leveraging blade is joined to said body portion by an angular junction.

11. The tool of claim 2, wherein said end portion of said leveraging blade is joined to said body portion by a curved junction.

12. The tool of claim 2, wherein said end portion is generally planar.

13. The tool of claim 2, wherein said end portion is generally curved.

14. The tool of claim 2, wherein the width of said edge of said end portion is no greater than half the width of said end portion.

15. The tool of claim 2, wherein said end portion is joined to said body portion at an angle of about 45 to 90 degrees.

16. The tool of claim 2, wherein said edge of said end portion is beveled.

17. A handheld tool for opening bivalve shellfish having a hinge, said tool comprising:
a handle adapted to be held in one hand, said handle having a first end and an opposing second end;
a leveraging blade extending from said second end of said handle, said leveraging blade having a body portion positioned adjacent said handle and an end portion joined in a non-planar manner to said body portion, said end portion having a generally linear edge, wherein said edge of said end portion is adapted to be inserted into a hinge of a shellfish such that a leveraging action can be applied to open the hinge; and
a first blade extending from said first end of said handle, said first blade being generally linear and flat and having a tapered portion and a tip member.

18. The tool of claim 17, wherein said end portion is joined to-said body portion at an angle of about 45 to 90 degrees.
